(19) United States
(12) Patent Application Publication
(10) Pub. No.: US 2005/0043827 A1
(43) Pub. Date: Feb. 24, 2005

(54) System and method for storing and accessing medical data

(75) Inventors: Richard J. Schaeffer, McMurray, PA (US); Richard F. Parker, Jacksonville, FL (US); James C. Kohler, Bethel Park, PA (US)

Correspondence Address: Bryan H. Opalko, Esquire;Buchanan Ingersoll PC, One Oxford Centre, 20th Floor, 301 Grant Street, Pittsburgh, PA, 15219, US

(73) Assignee: St. Clair Hospital, Pittsburgh, PA (US)

(21) Appl. No.: 10/893,619

(22) Filed: Jul. 16, 2004

Related U.S. Application Data
(60) Provisional application No. 60/487,657, filed on Jul. 16, 2003.

(51) Int. Cl. G05B 11/01

(52) U.S. Cl. 700/72; 711/115

(57) ABSTRACT

A method is provided according to the present invention for storing medical information onto a portable storage device. The inventive method generally includes the steps of providing a portable electronic data storage device directly connectable to a universal serial bus (USB) port of a computer,. and populating the portable electronic data storage device with medical information pertaining to a certain individual. The medical information includes a date indicator reference providing the date on which the portable electronic data storage device was last populated, i.e., the age of the medical information. Connecting the portable electronic data storage device to the USB port of a computer will allow the certain individual to view, but not edit, the medical information stored thereon.

### CROSS-REFERENCE TO RELATED APPLICATIONS

This application claims the benefit of co-pending provisional patent application Ser. No. 60/487,657 entitled “System and Method for Storing Medical Data”, filed on Jul. 16, 2003, the entire disclosure of which is incorporated by reference herein.

### FIELD OF THE INVENTION

The present invention is generally directed toward portable devices for electronically storing data and, more particularly, toward a system and method for storing and accessing medical information on a portable electronic data storage device.

### BACKGROUND OF THE INVENTION

Medical treatment today is typically provided at a variety of locations, including the offices of primary care physicians, specialists, clinics, hospitals, etc. When traveling on vacation or business, emergency or unanticipated treatment will often be administered by a set of healthcare providers different than those normally utilized by the individual. As a result, over the course of a lifetime an individual's medical records may be distributed over a large geographical area.

Since an individual's medical records may be widely distributed at multiple locations over a large area, obtaining the individual's medical records is often a very burdensome task and almost impossible to obtain on an urgent basis. Even when such records are available, they are typically kept on paper or photographic media, which are cumbersome and may be easily destroyed or damaged. Thus, paper-based medical records are often ineffective from a point of care perspective.

The continuing evolution of technological advancements have allowed consumers and business concerns, such as healthcare providers, to utilize wallet-sized cards that can hold various types of individual information. Such cards may be utilized for storing a user's financial records, medical history, or other confidential information. In the healthcare field, medical information concerning an individual is stored on a card by the various healthcare providers who have provided treatment to, or have examined, the individual. The individual can simply give the card to the healthcare provider during a visit. The provider can access the medical information on the card and view the patient's medical record, assisting the provider in diagnosing and treating the patient. Upon completion of the patient's visit, the card can be updated with the patient's updated medical information.

However, a problem with such cards is that they may become bent or folded, thus damaging the card and rendering the information stored thereon inaccessible. Additionally, the cards typically require a separate device to enable the information to be read from the card. If a patient does not have such a device, they will not be able to view their medical information. Further, if the information is not stored on the card in a user-friendly environment, it may be difficult for the patient and/or the healthcare service provider to view and navigate through the medical information. To maintain the confidentiality of the information stored on the card, a password or key maybe required to access the medical information. However, if the patient is unconscious or otherwise unable to provide the password or key, the medical information stored on the card will typically not be able to be accessed.

The present invention is directed toward overcoming one or more of the above-mentioned problems.

### SUMMARY OF THE INVENTION

A method is provided according to the present invention for storing medical information onto a portable storage device. The inventive method generally includes the steps of providing a portable electronic data storage device directly connectable to a universal serial bus (USB) port of a computer, and populating the portable electronic data storage device with medical information pertaining to a certain individual. The medical information includes a date indicator reference providing the date on which the portable electronic data storage device was last populated, i.e., the age of the medical information. Connecting the portable electronic data storage device to the USB port of a computer will allow the certain individual to view, but not edit, the medical information stored thereon.

A patient comment area may be provided on the portable electronic data storage device for allowing information to be entered therein by the certain individual. This information can then be viewed by the healthcare provider during a patient visit to assist in diagnosing and treating the patient.

In one form of the inventive method, the medical information includes a unique security code associated with the certain individual, such that the medical information can only be viewed after the entry of the unique security code. Additionally, the medical information includes an emergency security code which enables the medical information to be viewed by emergency personnel upon entry thereof. The emergency security code may be obtained by emergency personnel during emergency situations, and is programmed to change on a daily basis.

The medical information stored on the portable electronic data storage device is viewable as a web page displayed in a browser, and includes hyperlinks to various sections of the medical information. Physically, the medical information includes various reports, and the hyperlinks provide access to the various reports either in stand-alone format or within the body of the patent record. Since the medical information is viewable as a web page displayed in a browser, the various reports are capable of being e-mailed or printed from the browser.

The medical information pertaining to the certain individual stored on the portable electronic data storage device may be periodically updated. The updated medical information additionally includes a date indicator reference providing the date on which the portable electronic data storage device was last updated, i.e., the age of the updated medical information.

In another form of the inventive method, the step of updating the medical information on the portable electronic data storage device includes one of: (a) updating the medical information on the portable electronic data storage device during a patient visit to a healthcare provider (patient provides device to healthcare provider for updating); (b) connecting the portable electronic data storage device to a kiosk provided at the healthcare provider, with the kiosk updating the medical information stored on a portable electronic data storage device; or (c) remotely updating the medical information stored on the portable electronic data storage device via an Internet connection between the healthcare provider and the portable electronic data storage device.

The medical information is typically stored on the device in html format. For security purposes, the medical information is stored on the device in encrypted form. Unencription occurs automatically when the correct security code is entered.

In a further form of the inventive method, the step of populating the portable electronic data storage device with medical information includes the steps of receiving medical report files containing medical information pertaining to the certain individual, collating the received medical report files into a plurality of reports, converting the plurality of reports into a computer readable format, encrypting the plurality of reports, and storing the encrypted plurality of reports in a memory in the portable electronic data storage device.

In yet a further form of the inventive method, the populating step further includes the steps of merging the plurality of reports into a comprehensive file (also referred to herein as the patient record), extracting indexes from the comprehensive file for key subsections, creating subtext files containing information for the key subsections, and creating hyperlinks for accessing the key subsections, with the hyperlinks pointing to the key subsections either in the subtext files in stand-alone format or as part of the comprehensive file.

A system is also provided according to the present invention for storing medical information onto a portable storage device. The inventive system includes a receiver module receiving medical report files containing medical information pertaining to certain individual and formatting the received medical report files to a first format. A summarizer module receives the formatted medical report files from the receiver module and collates the medical report files into a plurality of reports. The plurality of reports are merged into a comprehensive file (patient record), converted into a computer readable format and encrypted for security purposes. The inventive system further includes a portable electronic data storage device directly connectable to a universal serial bus (USB) port of a computer, the portable electronic data storage device including a memory for storing the encrypted plurality of reports containing medical information (patient record). Connecting the portable electronic data storage device to the USB port of a computer allows the certain individual to view, but not edit, his or her medical information.

It is an object of the present invention to allow patients to received and manage a personal copy of their medical information from one or more healthcare providers.

It is a further object of the present invention to provide a personal and portable electronic data storage device that contains a copy of a patient's medical information.

It is an additional object of the present invention to collect, categorize and organize medical reports from various healthcare-related systems and provide such information on a portable electronic data storage device.

Other objects, aspects and advantages of the present invention can be obtained from the study of the specification, the drawings, and the appended claims.

### BRIEF DESCRIPTION OF THE DRAWINGS

FIGS. 1-2 are perspective views of exemplary portable electronic data storage devices which may be utilized in accordance with the present invention for storing patient medical information;

FIG. 3 is a perspective view illustrating an exemplary portable electronic data storage device connected to a USB port of a computer for viewing the patient medical information stored on the portable data storage device;

FIG. 4 is a screen shot for inputting a user name and password for accessing the patient medical information stored on the portable data storage device in accordance with the present invention;

FIG. 5 is a screen shot illustrating the daily calculation of the emergency security code for accessing the patient medical information stored on the portable data storage device;

FIG. 6 is a block diagram of a system for storing medical information to a portable electronic data storage device according to the present invention;

FIG. 7 is a screen shot of the main index page of a patient record stored on the portable data storage device;

FIG. 8 is a screen shot of a report file included as part of the patient record in stand-alone format;

FIG. 9 is a screen shot of a report file included as part of the patient record within the overall body of the patient record;

FIG. 10 is an alternate screen shot of the main index page which includes a picture of the patient;

FIG. 11 is a block diagram of kiosk-related updating for the portable electronic data storage device;

FIGS. 12-14 are screen shots provided to a user during kiosk-related updating of the portable electronic data storage device;

FIG. 15 is a block diagram of a generic Internet environment where a server at a healthcare organization is linked to user terminals via an Internet connection for updating of the portable data storage device; and

FIG. 16 is a screen shot of a date indicator reference provided to the user indicating the age of the medical information stored on the portable data storage device.

### DETAILED DESCRIPTION OF THE INVENTION

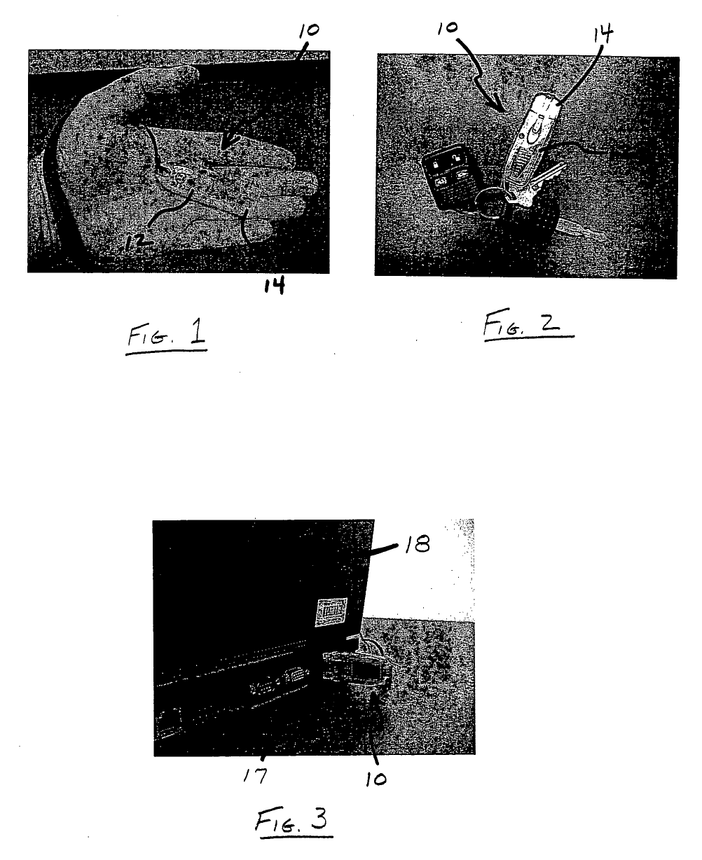

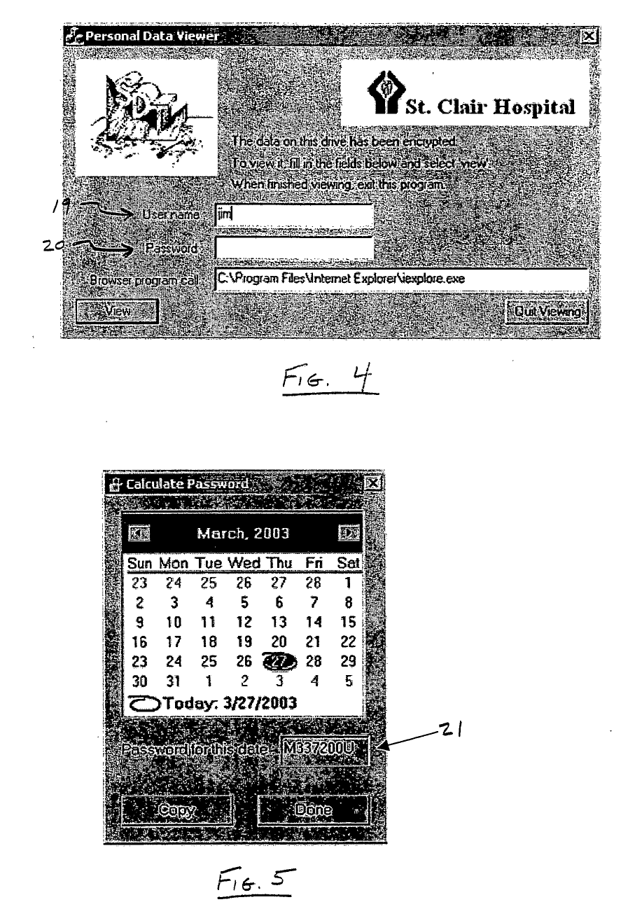

The present invention generally contemplates storing medical information on a USB mass storage device. As used herein, such a device can be any storage device connectable to a universal serial bus (USB) port of a computer for accessing the information stored thereon. FIGS. 1-2 illustrate exemplary USB mass storage devices that may be utilized in connection with the present invention. The devices, shown generally at 10, are small, portable devices which can typically fit in the hand of the user (FIG. 1) or be attached to a key chain (FIG. 2). The devices 10 are durable and typically include a body 12 and a cover 14 which may be made of plastic or other hard, polymer material. The device 10 typically includes a flash memory 15 (see FIG. 6) on which information, such as medical information, is stored. The cover 14 protects the USB port 16 (see FIG. 6) provided on the device 10 and helps to prevent the port 16 from being damaged and prohibits debris and/or dirt from entering the port 16. Typically, such devices 10 can have a storage capacity of 2 Gbytes and above.

As shown in FIG. 3, the device 10 is directly connectible to a USB port 17 provided on a computer 18. While the computer 18 is illustrated in FIG. 3 as a laptop computer, any type of computer or electronic device having a USB port may be utilized to view the medical information stored on the device 10. Typically, the computer 18 or other electronic device will include an executable program that will poll for the presence of the device 10, or any device, at the USB port 17 and will display the information stored thereon when the device 10 is detected. It should be understood that the devices 10 shown in FIGS. 1-3 are for exemplary purposes only and any type of USB mass storage device may be utilized in accordance with present invention without departing from the spirit and scope thereof.

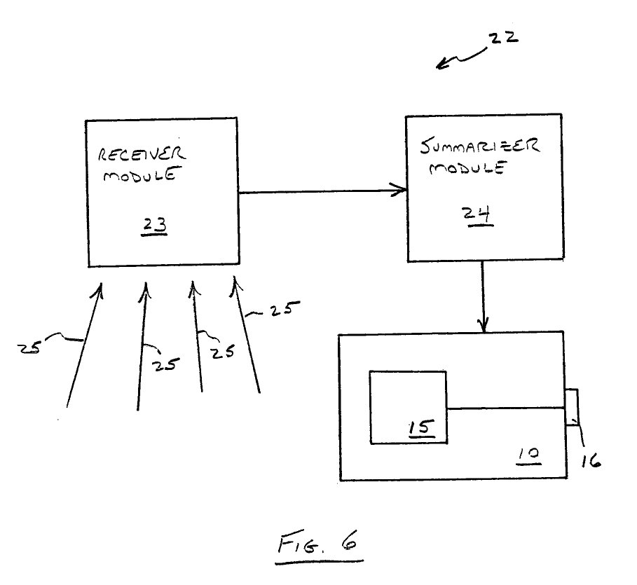

The medical information stored on the device 10 is encrypted for security purposes. The medical information includes a unique security code that must be input by a user in order to view the information on the device 10. When the medical information is loaded or populated onto the device 10, a user name and password are created in order to access the information. FIG. 4 illustrates a screen shot provided to a user at sign on. As shown in FIG. 4, a user must input the correct user name 19 and password 20 in order to access the medical information stored on the device 10. Unencription of the medical information occurs automatically when the correct user name 19 and password 20 are entered.

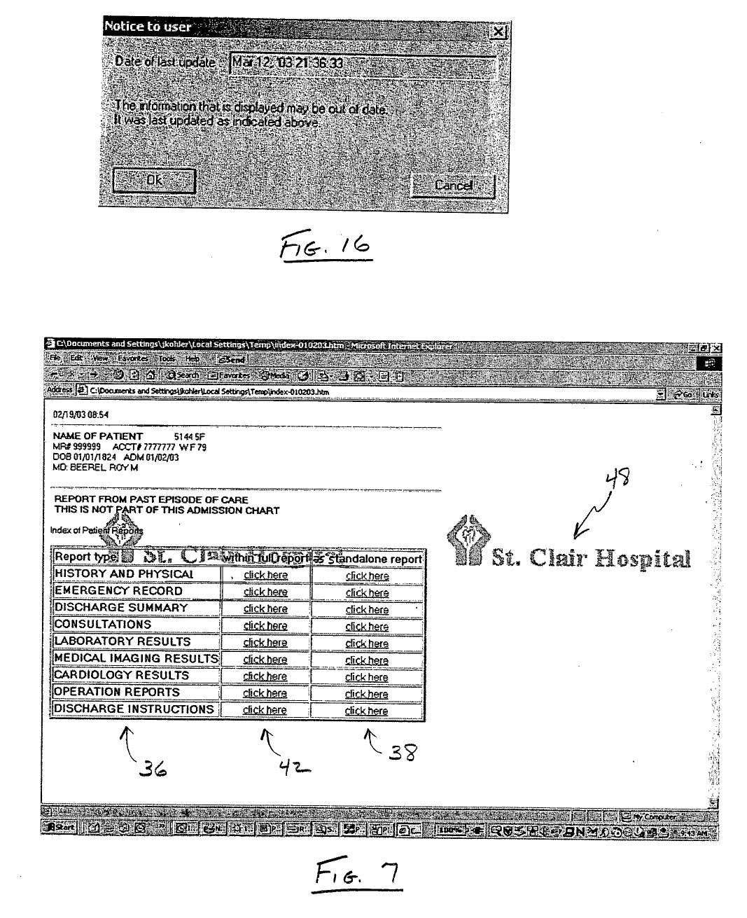

For emergency purposes, the medical information also includes an emergency security code allowing the medical information to be accessed in emergency situations. Standardized user names such as “EMT” may be utilized for the emergency security code. The password is calculated via an application that is provided to the healthcare organization or other administrative entity that distributes the device 10 to patients and their families. As show in FIG. 5, the password 21 for the emergency user is calculated on a date-based algorithm. This provides the healthcare organization with the ability to provide access that can only be used on the day of the emergency. If someone tries to access the medical information with the same user name and password (emergency security code) on a future date, they will not be permitted access. Typically, the device 10 will be labeled with the following information, or other similar information, to provide notice that the information contained thereon may be viewable in an emergency situation. For example, such a notice may include the following: “This device contains medical records for this patient. For instructions on viewing this record in an emergency situation call 412-344-6600 ext. 1177.” Additionally, the user name 19 and password 20 are provided herein as one type of security code, and other types of security codes may be implemented without departing from the spirit and scope of the present invention.

Additionally, after entering the correct user name 19 and password 20 (i.e., logging in), a disclaimer will appear on the screen. To continue, the user will be required to acknowledge the disclaimer by clicking “ok” or taking some other action. Upon acknowledgement, the device 10 will maintain, in the flash memory 15 or other memory, a non-editable, encrypted log of each individual who logged in to view the medical information and the date and time of such log in. If the disclaimer screen is omitted, this record will be stored upon the correct user name 19 and password 20 being entered. This information can additionally include access records of the healthcare provider when the medical information on the device 10 is updated. In this manner, the healthcare provider or organization has a record of who accessed the device 10 and when.

FIG. 6 illustrates a block diagram of a system, shown generally at 22, for populating the portable electronic data storage device 10 with medical information. The system 22 includes a receiver module 23 and a summarizer module 24. The receiver module 23 receives medical report files 25 containing medical information obtained for a certain individual and formats those files 25 into a specific format. The specific format provides for a variety of types of fonts, and renders the medical report files as specialized text reports in, for example, E7000 report format. The receiver module 23 can be configured to remove PCL codes from the report files 25 and replace them with cr/lf structuring. The receiver module 23 may receive the medical report files 25 from a variety of healthcare organizations or health-related professionals. The receiver module 23 receives the medical report files 25 and formats them to a specialized format (e.g., E7000 report format) that is readable by the summarizer module 24. After format conversion, the medical report files 25 are sent to an outbound queue in the receiver module 23, which relays the formatted reports to the next module, namely, the summarizer module 24.

The summarizer module 24 receives the formatted report files from the receiver module 23 and processes the reports in various stages. When a medical report file is initially received, it is time-stamped and assigned a document type. The document type describes how the report file will be extracted, such as where the patient's name is on the report file. A document type also assigns the following attributes to a report file.
A “provider id”, allowing multiple providers' data to coincide
A “patient id”, unique within a hospital, describing a particular patient.
An “event id”, unique within a hospital describing a visit or an event for a patient.
A “document id”, which allows multiple document types for a patient event.

In the next stage of processing, the summarizer module 24 collates the medical report files into a plurality of reports, and merges the plurality reports into a comprehensive file (i.e., the patient record). The starting page number and page count of the reports are tracked, along with patient and event identifying information. When all components have been located, the plurality of reports are merged into the comprehensive file. Indexes, or reference points, are extracted from the comprehensive file for key subsections. Typically, the key subsections will coincide with the plurality of reports. However, the present invention does not require that they do.

Subtext report files containing information for the key subsections are then created. The subtext files include certain information provided within the comprehensive file, but in a stand-alone format. The summarizer module 24 creates hyperlinks for accessing the key subsections, or subtext files. The hyperlinks point to the key subsections as viewed as part of the comprehensive file (patient record), and also as viewed in stand-alone format. The plurality of reports are converted into a computer readable format, such as, for example, html format, and encrypted for security purposes.

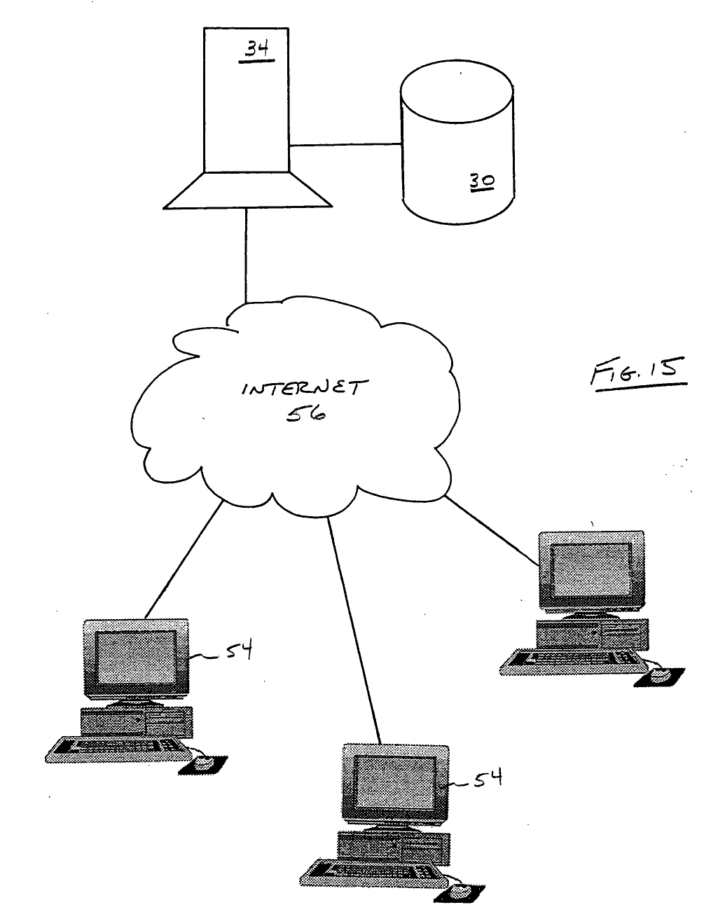

As shown in FIG. 6, the plurality of reports are then stored in the memory 15 of the portable electronic data storage device 10. In addition, the encrypted plurality of reports will also be stored in a database 30 (see FIGS. 11 and 15) associated with the healthcare provider. The database 30 is connectable to a kiosk 32 (FIG. 11) and a server 34 (FIG. 15), for purposes of updating the medical information stored on the device 10 as will be described infra.

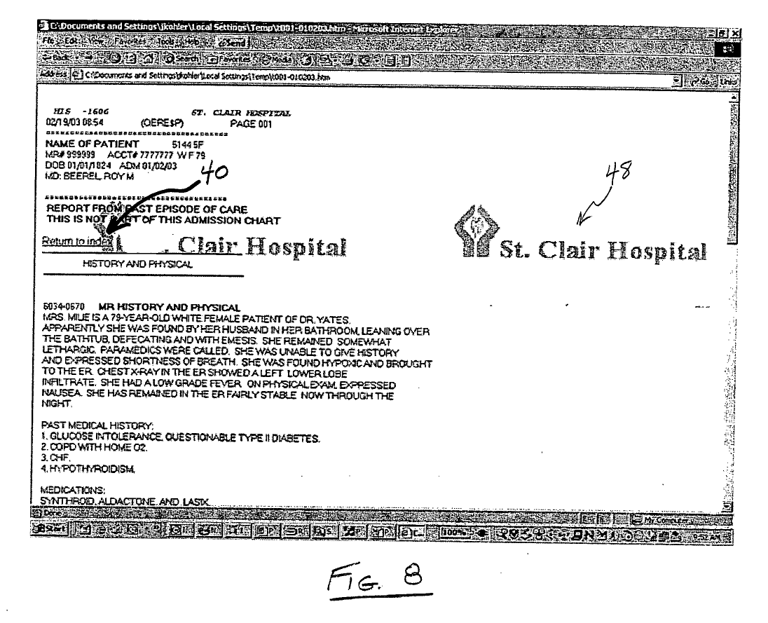

The medical information stored on the device 10 is designed to provide straight-forward navigation through the entire body of files or documents stored on the device 10. FIG. 7 illustrates a screen shot of the main index page of a patient record upon entry of the correct user name and password and acknowledgement of the disclaimer. As shown in FIG. 7, the patient record is presented to the user as a web page displayed in a browser, and thus the various reports included within the patient record are capable of being e-mailed or printed from the browser.

As shown in FIG. 7, the patient record includes a plurality of reports, or subtext files, shown at 36. The plurality of reports 36 basically refers to key subsections within the patient record, or comprehensive file. Options for navigating to the desired page are provided as hyperlinks. As shown in FIG. 7, hyperlinks 38 are provided to access the various reports 36 in stand-alone format. As an example, FIG. 8 illustrates the “HISTORY AND PHYSICAL” report 36 accessed in stand-alone format by clicking the appropriate hyperlink 38 pertaining thereto. The reports includes 36 a hyperlink 40 to return back to the main page (FIG. 7). Scrolling within the report 36 shown in FIG. 8 is limited to the content of the selected report, as the report 36 is provided in stand-alone format.

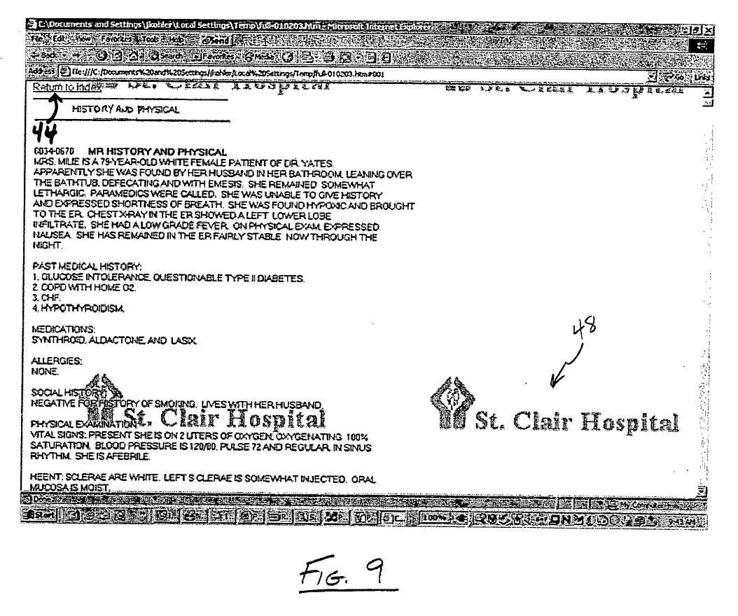

Referring back to FIG. 7, hyperlinks 42 are provided to enable the various reports 36 to be accessed as part of the overall patient record. FIG. 9 illustrates the “HISTORY AND PHYSICAL” record 36 accessed by clicking the appropriate hyperlink 42 associated therewith. As shown in FIG. 9, the “HISTORY AND PHYSICAL” report 36 is provided within the body of the overall patient record. A hyperlink 44 is provided to return the user to the main page (FIG. 7). Vertical scrolling will allow the user to move to any file, document, report or record within the overall comprehensive file.

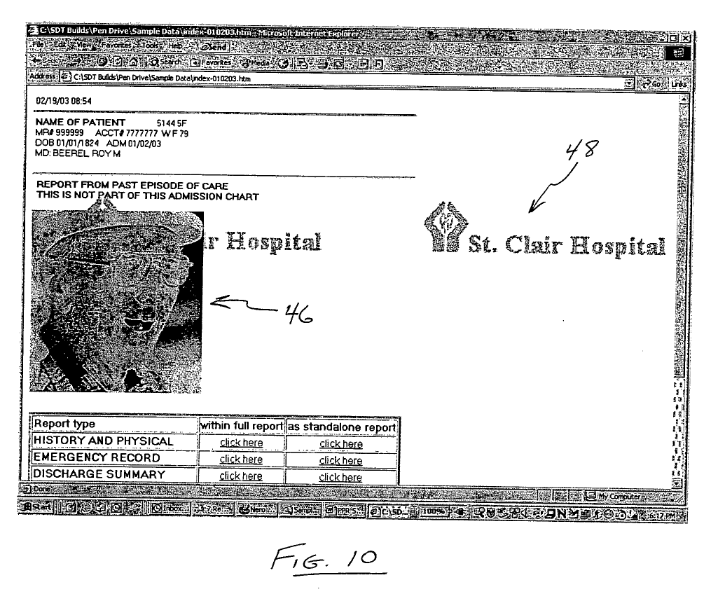

Various other information may be included within the comprehensive file. For example, as shown in FIG. 10, a picture 46 of the patient may be added to the comprehensive file. The picture 46 is generally added to the main index page. In addition to being useful in an emergency situation, the picture 46 may also be used for registration. Additionally, the patient record can include a watermark 48 of the healthcare organization that provided the device 10 to the patient. Typically, all of the medical information stored on the device 10 is stored in read-only format, enabling a user to view, but not edit, the medical information. However, a patient comment area is provided within the overall patient record allowing information to be entered therein by the patient and subsequently viewed by a healthcare provider. Such patient-recorded information may assist the healthcare provider in diagnosing and treating the patient.

Each time the patient visits a healthcare provider, the medical information stored on the device 10 may be updated. Updating may typically occur in one of three ways. First, a patient may simply present the device 10 to a healthcare provider during a visit. Upon completion of the visit, the healthcare provider will update the device 10 with updated medical information pertaining to the patient and return the device 10 to the patient.

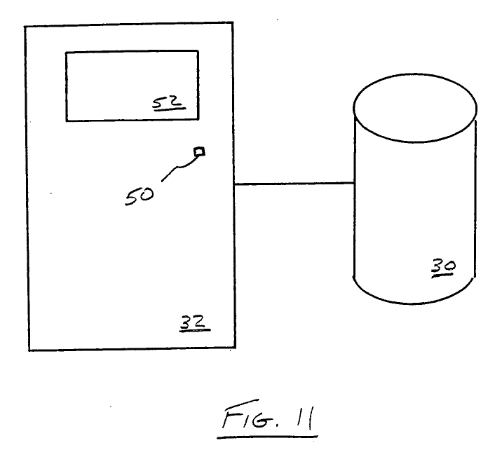

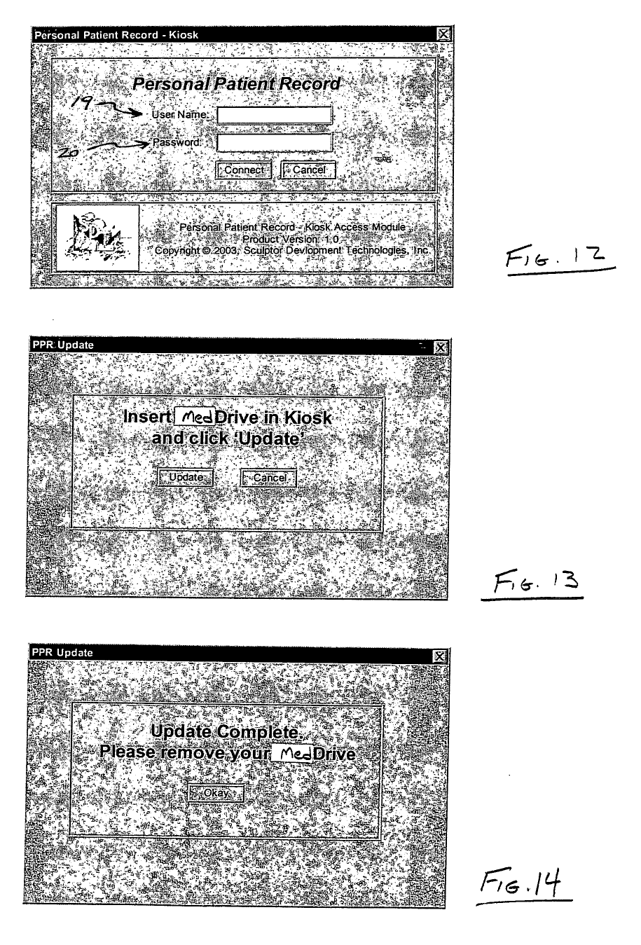

Alternately, a patient may utilize a kiosk 32, as shown in FIG. 11, to update the device 10. The kiosk 32 is typically provided at a healthcare organization's location, and enables the patient to update his or her device 10 without requiring a scheduled visit. The kiosk 32 includes a USB port 50 which mates with the USB port 16 on the device 10. As shown in FIG. 12, the kiosk 32 includes an initial sign on screen asking a patient for his or her unique security code consisting of a user name 19 and password 20. Upon entering the correct user name 19 and password 20 using, for example, a keypad and mouse arrangement, and acknowledging the disclaimer, a screen shot will appear on the kiosk screen 52, as shown in FIG. 13, instructing the patient to insert the device 10 into the kiosk 32 and click on “Update” to update the medical information stored on the device 10. The kiosk 32 retrieves the patient medical information from the database 30, which is provided at the healthcare organization, and transfers the updated medical information to the device 10. Upon completion of updating, the screen shot shown in FIG. 14 will appear informing the patient that the updating has been completed.

Finally, a patient may remotely update his or her device 10 via an Internet connection with a server 34 associated with and/or located at the healthcare organization, as shown in FIG. 15. After the device 10 has been initialized at a remote work station computer 54, a patient can connect to the server 34 via the Internet 56. While the computer 54 is illustrated in FIG. 15 as a desktop computer, a laptop computer or any other electronic device capable of wired or wireless connection to the Internet 56 may be utilized to update the medical information on the device 10 without departing from the spirit and scope of the present invention. The server 34 retrieves medical information pertaining to the patient from the database 30 and transfers the medical information via a secure Internet connection to the remote computer 54 where it is stored on the memory 15 of the device 10. Such a secure transfer of data is well-known in the relevant field and, accordingly, a detailed description thereof is not necessary.

Each time the device 10 is populated or updated with medical information, a date indicator reference is included providing the date on which the portable electronic data storage device 10 was last populated or updated. For example, as shown in FIG. 16, a notice is provided to the user upon initiation of the device 10 informing the user of the age of the medical information contained on the device 10. If the user wishes to continue after viewing the age of the medical information, the user will simply click “ok” to access the main page of the patient record (FIG. 7).

Typically, the medical information is stored on the device 10 utilizing a Tamper-Evident File System (TEFS) that adds security to the individual files and assures that any changes to a file will prevent both the change, and subsequent data in the file, from being displayed. To help prevent accidental file modification, all TEFS data files stored on the device 10 are stored with the read-only attribute enabled. The TEFS data files typically take two forms. Most of the data is stored in a structured table format, with a 32-bit CRC (Cyclic Redundancy Check) value at the end of each structure. When tables of medical information data are loaded, the CRC value is checked. If the result doesn't match existing value, the record is cleared from memory during loading. In a structured read operation, subsequent records can be displayed if they are unaltered. For free form data, such as the text in the later portion of the “.dat” files, information is broken into 8 kbits or less data chunks. The length of the data chunk is stored in a leading field and the 32-bit CRC value is stored at the end of the data chunk. Again, if the CRC value calculated during a read operation doesn't match the stored value, the read of the file stops at that point. Both the data length and CRC values are encrypted along with the rest of the data, providing another layer of protection to the original medical information data.

The inventive system and method thus provides an easy way for patients to receive and manage a personal copy of their medical information from one or more healthcare providers. This can provide easier transition for a patient where the next provider can get immediate access to the patient's medical history, even if it spans multiple healthcare providers. Additionally, the data is easily accessed by a patient, in read-only format, by simply connecting the device to the USB port of a computer. A personal comment area is provided for the patient to enable him or her to input personal information, which may also) be readable by healthcare providers to assist in diagnosing and treating the patient.

Additionally, while the device 10 has been described herein as containing medical information for one individual only, medical information for a plurality of individuals may be stored on one device 10, with each individual having their own unique personal and emergency security codes to access their individual medical information data. In this manner, medical information for various family members may be stored on one portable electronic data storage device 10.

While the present invention has been described with a particular reference to the drawings, it should be understood that various modifications could be made without departing from the spirit and scope of the present invention.

1. A method of storing medical information comprising the steps of:
providing a portable electronic data storage device directly connectable to a universal serial bus (USB) port of a computer; and
populating the portable electronic data storage device with medical information pertaining to a certain individual, wherein the medical information includes a date indicator reference providing the date on which the portable electronic data storage device was last populated with medical information,
wherein connecting the portable electronic data storage device to the USB port of a computer allows the certain individual to view but not edit the medical information.

2. The method of claim 1, wherein the medical information includes a unique security code associated with the certain individual, and wherein the medical information can only be reviewed after entry of the unique security code.

3. The method of claim 2, wherein the medical information includes an emergency security code which enables the medical information to be viewed, wherein the emergency security code changes on a daily basis.

4. The method of claim 1, wherein the medical information is viewable as a web page displayed in a browser, and wherein the medical information includes hyperlinks to various sections of the medical information.

5. The method of claim 4, wherein the medical information includes a plurality of reports, and wherein the hyperlinks provide access to the plurality of reports.

6. The method of claim 5, wherein the plurality of reports are part of a patient record for the certain individual, and wherein the hyperlinks provide access to the plurality of reports either in stand-alone format or within the body of the patient record.

7. The method of claim 5, wherein the plurality of reports are capable of being e-mailed or printed from the browser.

8. The method of claim 1, further comprising the step of updating the medical information stored on the portable electronic data storage device pertaining to the certain individual, wherein the updated medical information includes a date indicator reference providing the date on which the portable electronic data storage device was last updated.

9. The method of claim 8, wherein the step of updating the medical information on the portable electronic data storage device comprises one of:
(a) updating the medical information pertaining to the certain individual on the portable electronic data storage device during a patient visit to a healthcare provider, wherein the portable electronic data storage device is provided to the healthcare provider for updating;
(b) connecting the portable electronic data storage device to a kiosk located at the healthcare provider, wherein the kiosk updates the medical information stored on the portable electronic data storage device; or
(c) remotely updating the medical information stored on the portable electronic data storage device via an Internet connection between the healthcare provider and the portable electronic data storage device.

10. The method of claim 1, wherein the medical information is stored in html format.

11. The method of claim 1, wherein the medical information is stored in encrypted form.

12. The method of claim 1, wherein the step of populating the portable electronic data storage device with medical information pertaining to a certain individual comprises the steps of:
receiving medical report files containing medical information pertaining to the certain individual;
collating the-received medical report files into a plurality of reports;
converting the plurality of reports into a computer readable format;
encrypting the plurality of reports; and
storing the encrypted plurality of reports in a memory in the portable electronic data storage device.

13. The method of claim 12, wherein the step of populating the portable electronic data storage device with medical information pertaining to a certain individual further comprises the steps of:
merging the plurality of reports into a comprehensive file;
extracting indexes from the comprehensive file for key subsections;
creating subtext files containing information for the key subsections; and
creating hyperlinks for accessing the key subsections, the hyperlinks pointing to the key subsections in at least one of the comprehensive file and the subtext files.

14. The method of claim 1, further comprising the step of providing a patient comment area on the portable electronic data storage device allowing information to be entered therein by the certain individual.

15. The method of claim 1, further comprising the step of tracking each time a user accesses the portable electronic data storage device to view the medical information stored thereon.

16. A system for storing medical information, the system comprising:
a receiver module receiving medical report files containing medical information pertaining to a certain individual and formatting the received medical report files to a first format;
a summarizer module receiving the formatted medical report files, collating the medical report files into a plurality of reports, converting the plurality of reports into a computer readable format, and encrypting the plurality of reports; and
a portable electronic data storage device directly connectable to a universal serial bus (USB) port of a computer, the portable electronic data storage device including a memory for storing the encrypted plurality of reports, wherein connecting the portable electronic data storage device to the USB port of a computer allows the certain individual to view but not edit the medical information.

17. The system of claim 16, wherein the medical information includes a date indicator reference providing the date on which the portable electronic data storage device was last populated or updated with medical information.

18. The system of claim 16, further comprising a kiosk located at a healthcare provider, wherein the medical information stored on the portable electronic data storage device is updatable by connection of the portable electronic data storage device to the kiosk.

19. The system of claim 16, further comprising a server associated with a healthcare provider, wherein the medical information stored on the portable electronic data storage device is updatable via an Internet connection between the server and the portable electronic data storage device.

20. The system of claim 16, wherein the medical information includes a unique security code and an emergency security code permitting access to the medical information, wherein the unique security code is associated with the certain individual, and wherein the emergency security code changes on a daily basis.

21. The system of claim 16, wherein the medical information is viewable as a web page displayed in a browser, and includes hyperlinks to various sections of the medical information.

22. The system of claim 16, wherein the portable electronic data storage device includes a patient comment area allowing information to be entered therein by the certain individual.
